(19) United States
(12) Patent Application Publication
(10) Pub. No.: US 2018/0242506 A1
(43) Pub. Date: Aug. 30, 2018

(54) QUICK-CHANGE HARROW TINE ASSEMBLY

(71) Applicant: F.P. Bourgault Tillage Tools Ltd., St. Brieux (CA)

(72) Inventors: Joseph Bourgault, St. Brieux (CA); Dean Marvin Bigelow, St. Brieux (CA)

(21) Appl. No.: 15/123,286

(22) PCT Filed: Apr. 13, 2016
(86) PCT No.: PCT/CA2016/000109

§ 371 Date: Sep. 2, 2016

Related U.S. Application Data
(60) Provisional application No. 62/257,947, filed on Nov. 20, 2015.

(51) Int. Cl. A01B 23/02; A01B 19/02

(52) U.S. Cl. CPC A01B 23/02; A01B 19/02

(57) ABSTRACT

A quick-change harrow tine assembly wherein a first member is selectively and non-rotatably connected to a second member, allowing for replacement of damaged or worn harrow tine segments or tine tips without requiring replacement of the entire coil tine unit.

### FIELD OF THE INVENTION

The present invention relates to harrow tines, and more particularly to means of repairing or replacing damaged or worn tines.

### BACKGROUND OF THE INVENTION

The use of harrow tines is ubiquitous in agricultural crop production. Tines extend downwardly from an arm of an implement and can be used for a number of purposes, including for example spreading straw evenly across a field once the crop has been harvested, smoothing and levelling the field prior to seeding, packing a field once the field has been seeded to improve seed compaction (to improve seed germination), preserving soil moisture while doing a weed kill at the same time, or tilling an undesirably wet soil surface to help dry it out. In one conventional arrangement, a pair of spring steel tines are connected by a coil, forming a U-shaped unit that can be mounted to an implement for movement across a target field, although single-tine configurations are commercially available and in use.

However, to achieve the desired functionality, tines are commonly constructed to be somewhat flexible. This may have particular utility where, for example, the tines are being used to till the upper soil and may engage forcefully with not only hard soil but also rocks as the implement moves across the field. The result, well known to the skilled person, is that tines wear down with time or may bend. Wear is more common on the tine tips and also severe bending often occurs in the middle of the tines. Breakage may sometimes even occur on one of the two upper coil segments connected to the two tines.

The common solution to the problem of tine wear or bending is to replace the entire tine, which usually means replacing a coil-style tine pair, and in the case of an upper coil segment break would require replacing the whole tine pair. Replacing a tine pair is a very labour-intensive and time-consuming process, as the operator must disassemble the harrow bar which holds the worn or broken tine. In addition, tine pairs are costly to replace, particularly given the number of tines on an implement and the rate at which wear commonly occurs. For example, it is known to have harrow implements with 204 tine pairs for an 82 foot harrow bar, with more tines for wider machines up to 100 feet wide. An 82 foot unit has a total of 408 individual tines that can be and are subject to constant wear during use.

There have been attempts in the past to provide replaceable tine tips, to present a more cost-effective solution than replacing an entire tine pair. For example, Canadian Patent No. 1,271,081 to Dalyea discloses a two-part tine with a sleeve for connecting the tine segments, the basic concept being that a worn or broken lower tine segment can be replaced by removing either the lower tine from the sleeve (where they are removably connected) or replacing the lower tine and sleeve (where the sleeve is removably connected to the upper tine). Dalyea teaches the use of welding, crimping or small set bolts for retaining the tine segments within the sleeve.

However, the Dalyea tine replacement design suffers from significant drawbacks, and clearly would not be desirable for farmers. The set bolts protrude from the sleeve sides, and the top of the sleeve is flat, such that straw can catch and potentially bunch up and cause plugging of the harrows. Also, the upper and lower tines are taught to be distanced from each other within the sleeve, the result being that all of the upward vertical force or load is on the points where the set bolts engage the tine segment surfaces, which will cause set bolt loosening and wear on the tips of the set bolts, allowing them to twist and disengage from the tine segments, ultimately resulting in the loss of the tine tip segment. It is also highly unlikely that a set bolt pressed into the tine surface would securely maintain the lower tine in the sleeve, as the jarring and flexing a tine is subjected to would likely loosen such an engagement. In addition, the use of welding or crimping would have disadvantages. Welding could cause breakage, micro-cracks or stress risers in spring steel, and crimping simply leaves the operator with tine segments that cannot be removed from the sleeve without destroying the claimed utility—namely the ability to replace worn tines and keep operating the implement. Crimping generally produces a connection that cannot be undone without damaging one or both of the connected components, which then results in increased replacement costs.

Finally, modern spring steel harrow tines are increasingly being provided with leading edge hard face such as solid or embedded tungsten carbide wear plates, and therefore the tips must not be allowed to turn sideways or rearwardly. With the Dalyea design, it is highly unlikely that the lower tine would be prevented from rotation within the sleeve—assuming it does not disengage from the sleeve altogether—with the result that the hard face leading edge could end up twisting sideways or rearwardly and the desired utility is then lost.

What is needed, therefore, is a harrow tine design that allows for quick change of worn, bent or broken lower tine sections and/or the ability to remove and replace the upper coil segment if it breaks, without having to dispose of expensive solid or embedded tungsten carbide tips and connectors and while avoiding some or all of the above disadvantages of the prior art assembly.

### SUMMARY OF THE INVENTION

The present invention therefore seeks to provide a harrow tine assembly, useful in a single-tine or tine pair configuration, that allows for simpler and faster replacement of worn or damaged tine segments or tine tips.

According to a first broad aspect of the present invention, there is provided a harrow tine assembly comprising:
a first tine segment;
a second tine segment; and
a cross member;
the first tine segment comprising an axial cavity and a transverse passage, the transverse passage impinging on the axial cavity;
an end of the second tine segment retained within the axial cavity, the end comprising a transverse channel in a surface thereof;
the cross member received within the transverse passage and engaging the transverse channel to non-rotatably lock the first and segment tine segments, such that removal of the cross member from the transverse passage allows disconnection of the first and second tine segments.

In some exemplary embodiments of the first aspect, the first tine segment comprises a tine tip and the second tine segment comprises an upper tine segment. In some other exemplary embodiments, the first tine segment comprises an upper tine segment and the second tine segment comprises a lower tine segment. The axial cavity may extend between first and second openings, receiving the end of the second tine segment in the first opening and a third tine segment in the second opening.

According to a second broad aspect of the present invention, there is provided a harrow tine adaptor for receiving and selectively retaining a tine segment, the harrow tine adaptor comprising:
an axial cavity; and
a transverse passage, the transverse passage impinging on the axial cavity;
the axial cavity configured for receipt of an end of the tine segment, the end comprising a transverse channel in a surface thereof;
the transverse passage configured for receipt of a cross member;
the cross member engaging the transverse channel when received within the transverse passage to non-rotatably lock the harrow tine adaptor and the tine segment, such that removal of the cross member from the transverse passage allows disconnection of the harrow tine adaptor and the tine segment.

According to a third broad aspect of the present invention, there is provided a harrow tine assembly comprising:
an upper tine segment comprising a lower end;
a lower tine segment comprising:
   an upper end; and
   a transverse channel in a surface of the lower tine segment spaced from the upper end;
a connector comprising an axial cavity retaining the lower end of the upper tine segment and the upper end and the transverse channel of the lower tine segment, the connector comprising a transverse passage therethrough at a location beside the transverse channel; and
a cross member selectively retained within the transverse passage and engaging the transverse channel, such that the lower tine segment and the connector are non-rotatably engaged.

In some exemplary embodiments of the third aspect, the assembly further comprises an upper transverse channel in a surface of the upper tine segment, an upper transverse passage through the connector, and an upper cross member retained within the upper transverse passage and engaging the upper transverse channel, such that the upper tine segment and the connector are non-rotatably engaged. The lower end of the upper tine segment and the upper end of the lower tine segment preferably abut within the axial cavity, and the assembly preferably further comprises an axial gap extending from an outer surface into the axial cavity.

According to a fourth broad aspect of the present invention, there is provided a harrow tine assembly comprising:
an upper tine segment comprising a lower end, the lower end having an off-normal angled lower engagement face;
a lower tine segment comprising an upper end and a recess in a surface of the lower tine segment spaced from the upper end, the upper end having an off-normal angled upper engagement face corresponding to the off-normal angled lower engagement face of the lower end of the upper tine segment;
a connector comprising:
   an axial cavity retaining the lower end of the upper tine segment and the upper end and the recess of the lower tine segment; and
   a passage extending from an outer surface into the axial cavity beside the recess; and
a cross member selectively retained within the passage and engaging the recess;
the lower end of the upper tine segment abutting the upper end of the lower tine segment within the axial cavity such that the off-normal angled lower engagement face and the off-normal angled upper engagement face are in facial engagement;
such that the upper tine segment, the lower tine segment and the connector are non-rotatably engaged.

In exemplary embodiments of the fourth aspect, the assembly further comprises an upper recess in a surface of the upper tine segment spaced from the lower end, an upper passage extending from the outer surface of the connector into the axial cavity beside the upper recess, and an upper cross member retained within the upper passage and engaging the upper recess.

According to a fifth broad aspect of the present invention, there is provided a harrow tine assembly comprising:

a tine tip comprising:
an axial cavity; and
a transverse passage passing at least partially through the tine tip and impinging on the axial cavity;

an upper tine segment comprising a lower end, the lower end comprising a transverse channel in a surface thereof, the lower end received within the axial cavity such that the transverse channel aligns with the transverse passage; and

a cross member selectively retained within the transverse passage and engaging the transverse channel, such that the upper tine segment and the tine tip are non-rotatably connected;

such that removal of the cross member from the transverse passage allows removal of the lower end from the axial cavity.

In some exemplary embodiments of the fifth aspect, the tine tip comprises a wear-resistant leading surface, which may for non-limiting example comprise a wear-resistant member attached to a leading face of the tine tip. In some exemplary embodiments, a downwardly-facing surface of the tine tip is wear resistant, and the downwardly-facing surface may comprise a wear-resistant member.

In some embodiments the tine tip further comprises an axial gap extending from an outer surface into the axial cavity, such that closing the axial gap securely retains the lower end of the upper tine segment in the axial cavity. Where such an axial gap is present, some embodiments comprise the transverse passage extending across the axial gap and the cross member is a bolt threadably received in the transverse passage, such that tightening the bolt closes the axial gap.

According to a sixth broad aspect of the present invention, there is provided a harrow tine assembly comprising:

a tine tip comprising:
an axial cavity;
an axial gap extending from an outer surface of the tine tip into the axial cavity;
at least one transverse passage passing at least partially through the tine tip and impinging on the axial cavity; and
at least one gap-spanning passage passing at least partially through the tine tip and across the axial gap;

an upper tine segment comprising:
a lower end received within the axial cavity; and
at least one transverse channel in a surface of the lower end such that each transverse channel aligns with the corresponding transverse passage impinging on the axial cavity;

a locking cross member selectively retained within each transverse passage; and

a tightening cross member selectively retained within each gap-spanning passage;

the locking cross member releasably and non-rotatably connecting the upper tine segment and the tine tip; and

the tightening cross member for selectively closing the axial gap to securely retain the lower end of the upper tine segment in the axial cavity.

In some exemplary embodiments of the sixth aspect, the tine tip comprises a wear-resistant leading surface, which may for non-limiting example comprise a wear-resistant member attached to a leading face of the tine tip. In some exemplary embodiments, a downwardly-facing surface of the tine tip is wear resistant, and the downwardly-facing surface may comprise a wear-resistant member.

The tightening cross member may be a bolt threadably received in the gap-spanning passage.

According to a seventh broad aspect of the present invention, there is provided a removable harrow tine tip for use with a harrow tine segment, the harrow tine segment having a lower end with a surface comprising a transverse channel, the tip comprising:

an axial cavity;

a transverse passage impinging on the axial cavity; and

a cross member selectively receivable within the transverse passage;

the axial cavity configured for receipt of the lower end such that the transverse channel aligns with the transverse passage; and

the cross member configured to engage the transverse channel when received within the transverse passage;

such that the upper tine segment and the tine tip are non-rotatably connected when the lower end is received within the axial cavity and the cross member is received within the transverse passage to engage the transverse channel; and

such that removal of the cross member from the transverse passage allows removal of the lower end from the axial cavity.

In some exemplary embodiments of the seventh aspect, the harrow tine tip comprises a wear-resistant leading surface, which may for non-limiting example comprise a wear-resistant member attached to a leading face of the harrow tine tip. In some exemplary embodiments, a downwardly-facing surface of the harrow tine tip is wear resistant, and the downwardly-facing surface may comprise a wear-resistant member.

In some embodiments the harrow tine tip further comprises an axial gap extending from an outer surface into the axial cavity, such that closing the axial gap securely retains the lower end of the upper tine segment in the axial cavity. Where such an axial gap is present, some embodiments comprise the transverse passage extending across the axial gap and the cross member is a bolt threadably receivable in the transverse passage, such that tightening the bolt closes the axial gap.

According to an eighth broad aspect of the present invention, there is provided a harrow tine assembly comprising:
an upper tine segment comprising a lower end, the lower end comprising an upper transverse channel in a surface thereof;
a lower tine segment comprising an upper end and an opposite end, the upper end comprising a lower transverse channel in a surface thereof;
a connector comprising:
   an axial cavity extending between upper and lower openings, the upper opening selectively retaining the lower end and the upper transverse channel and the lower opening selectively retaining the upper end and the lower transverse channel;
   an upper transverse passage impinging the axial cavity at a location beside the upper transverse channel; and
   a lower transverse passage impinging the axial cavity at a location beside the lower transverse channel;
an upper cross member selectively retained within the upper transverse passage and engaging the upper transverse channel to lock the upper tine segment to the connector;
a lower cross member selectively retained within the lower transverse passage and engaging the lower transverse channel to lock the lower tine segment to the connector; and
a tine tip, the tine tip comprising:
   a tip axial cavity;
   a tip transverse passage impinging on the tip axial cavity; and
   a tip cross member selectively receivable within the tip transverse passage;
   the tip axial cavity configured for receipt of the opposite end of the lower tine segment, the opposite end of the lower tine segment having a tip transverse channel is a surface thereof, such that the tip transverse channel aligns with the tip transverse passage; and
   the tip cross member configured to engage the tip transverse channel when received within the tip transverse passage, thus locking the tine tip to the lower tine segment.

A detailed description of exemplary embodiments of the present invention is given in the following. It is to be understood, however, that the invention is not to be construed as being limited to these embodiments. The exemplary embodiments are directed to a particular application of the present invention, while it will be clear to those skilled in the art that the present invention has applicability beyond the exemplary embodiments set forth herein.

### BRIEF DESCRIPTION OF THE DRAWINGS

In the accompanying drawings, which illustrate exemplary embodiments of the present invention:

FIG. 1 is a front left perspective view of a first embodiment of the present invention, with the upper and lower tine segments disengaged from the connector;

FIG. 2 is a rear right perspective view of the first embodiment, with the upper and lower tine segments disengaged from the connector and the cross members disengaged from the passages;

FIG. 3 is rear perspective view of the first embodiment;

FIG. 4 is a front right perspective view of a second embodiment of the present invention, with the upper and lower tine segments disengaged from the connector;

FIG. 5 is a rear perspective view of the second embodiment, with the lower tine segment disengaged from the connector and the cross member disengaged from the passage;

FIG. 6 is a rear perspective view of the second embodiment;

FIG. 7 is a rear elevation view of a third embodiment of the present invention;

FIG. 8a is a perspective view of a fourth embodiment of the present invention;

FIG. 8b is a side elevation view of the fourth embodiment;

FIG. 9 is a side elevation view of a harrow tine segment according to an embodiment of the present invention;

FIG. 10 is a sectional view of the fourth embodiment;

FIG. 11 is a rear elevation view of the fourth embodiment;

FIG. 12 is a perspective view of a fifth embodiment of the present invention;

FIG. 13 is a side elevation view of the fifth embodiment;

FIG. 14 provides top plan, side elevation and rear elevation views of the fifth embodiment;

FIG. 15 provides top plan and side elevation views of a sixth embodiment of the present invention;

FIG. 16 is a front perspective view, partially exploded, of a seventh embodiment of the present invention;

FIG. 17 is a detailed exploded view of a connection between a tine segment and a tine tip according to the seventh embodiment; and

FIG. 18 is a detailed exploded view of a connection between upper and lower tine segments and a connector according to the seventh embodiment.

Exemplary embodiments of the present invention will now be described with reference to the accompanying drawings.

### DETAILED DESCRIPTION OF EXEMPLARY EMBODIMENTS

Throughout the following description specific details are set forth in order to provide a more thorough understanding to persons skilled in the art. However, well known elements may not have been shown or described in detail to avoid unnecessarily obscuring the disclosure. The following description of examples of the technology is not intended to be exhaustive or to limit the invention to the precise form of any exemplary embodiment. Accordingly, the description and drawings are to be regarded in an illustrative, rather than a restrictive, sense.

The present invention is directed to quick-change harrow tine assemblies incorporating non-rotation features, so that worn or damaged tines or tine segments can be replaced, but are also prevented from rotating so that hard facing or highly durable wear plates remain pointed in the direction of travel. As stated above, the present invention may have application with single-tine or tine pair configurations.

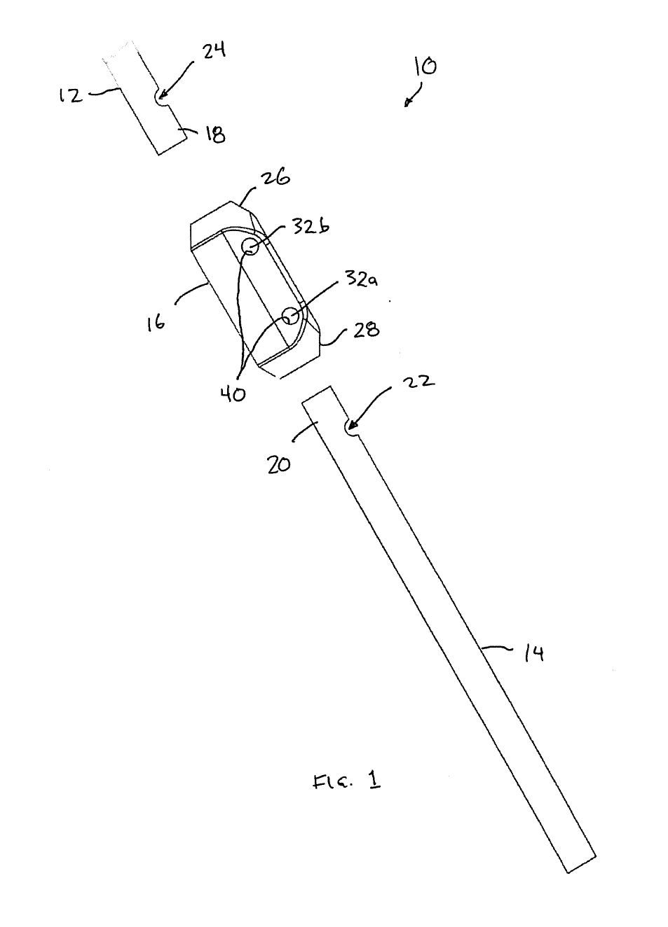

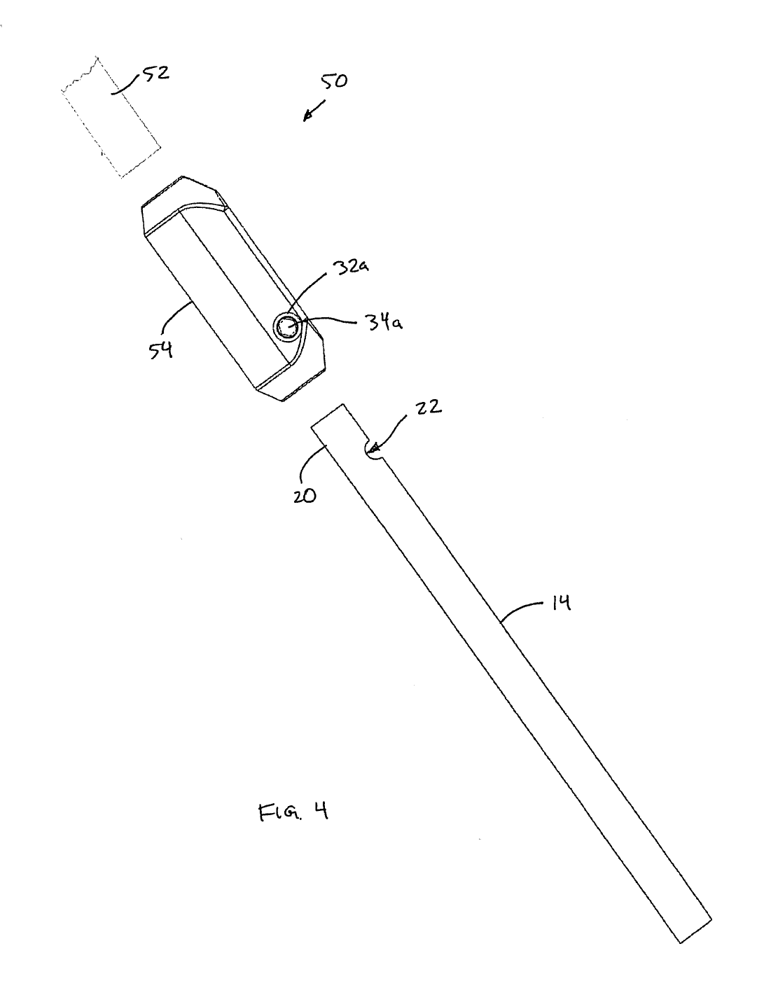

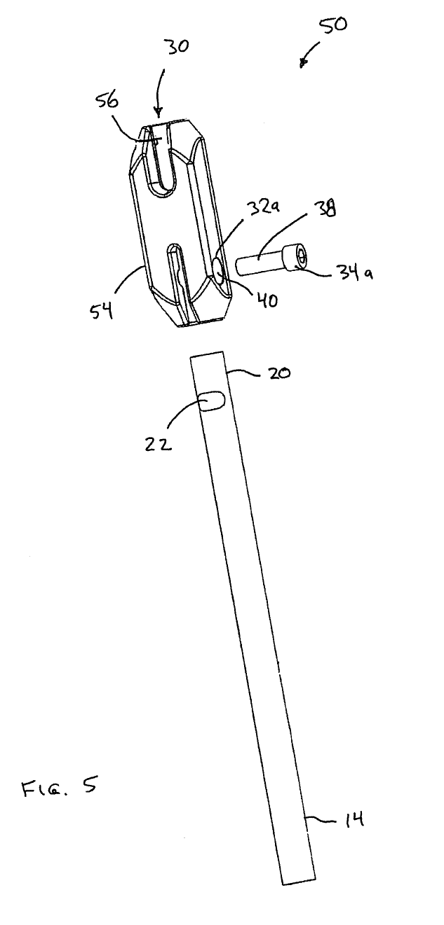

Turning to FIGS. 1 to 3, a first embodiment of the present invention is illustrated. A harrow tine assembly 10 is shown, which provides non-rotational coupling of an upper tine segment 12 and a lower tine segment 14 using a connector 16. This embodiment is intended to be of primary use for tine units originally manufactured to incorporate the present invention, whereas the embodiment of FIGS. 4 to 6 is primarily intended as a retrofit of existing tine units, as will be described below.

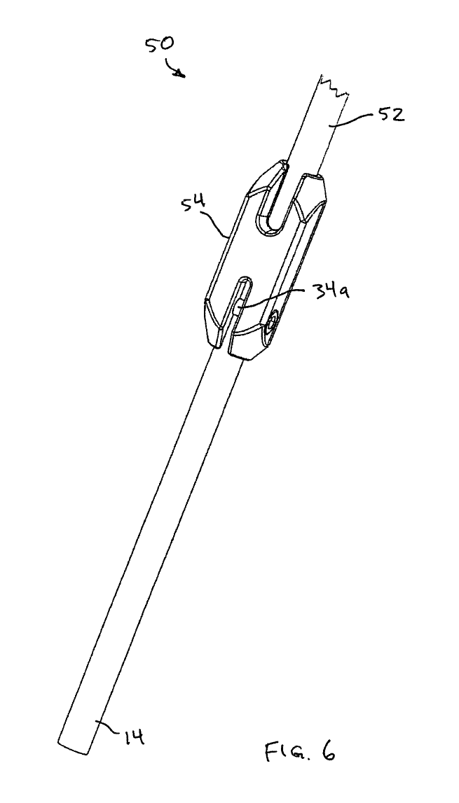

The upper tine segment 12 would be connected at its upper end to a coil segment of a tine unit (see FIG. 7 for an illustration of a conventional coil segment). In the embodiment of FIGS. 1 to 3, the upper tine segment 12 is provided with a transverse channel 24 at a lower end 18 of the segment 12. The channel 24 is configured for slip-fit receipt of a cross member 34b when the assembly 10 is fully assembled, as is described below. The lower tine segment 14 is provided with a transverse channel 22 at an upper end 20 of the segment 14, the channel 22 configured for slip-fit receipt of a cross member 34a when the assembly 10 is fully assembled, as is described below.

The connector 16 is provided with beveled top and bottom surfaces 26, 28. It is believed that these beveled surfaces may help to avoid accumulation or bunching of straw or other materials on the harrow tines. While the connector could be made from any material deemed suitable by a skilled person, it is preferably composed of a durable cast material.

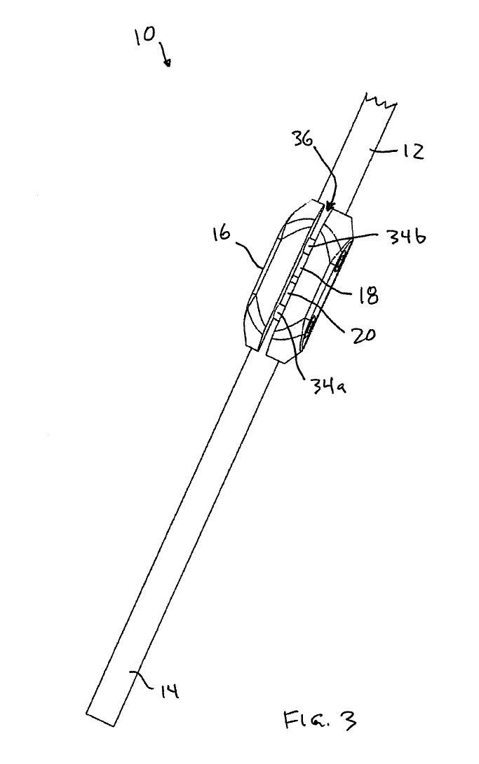

The connector 16 is also provided with an axial cavity 30 extending throughout the connector 16, sized for receipt of both the lower end 18 of the upper tine segment 12 and the upper end 20 of the lower tine segment 14. Although FIG. 3 illustrates a slight gap between the upper and lower tine segments 12, 14 when inserted and secured within the axial cavity 30, it is preferable for the segments 12, 14 to touch to avoid having the upward vertical force or load on the cross members 34a,b. That being said, the upper and lower tine segments 12, 14 when inserted and secured within the axial cavity 30 may be alternatively set at a distance of up to ¼ inch between them, or even a greater distance, with an appropriate assembly design that takes into account the need to prevent shearing of the cross members, which would be within the knowledge of the person skilled in the art.

The connector 16 is also provided with two transverse passages 32a,b, which are sized and configured for receipt of the two cross members 34a,b, which in the illustrated embodiment are threaded bolts. The passages 32a,b pass through the connector 16, such that when the tine segments 12, 14 are inserted in the axial cavity 30 the cross members 34a,b pass through one side of the connector 16 (via the passages 32a,b), through the channel 22, 24 and through the other side of the connector 16 (via the passages 32a,b). This can best be seen in FIG. 3.

The cross members 34a,b are threaded bolts in the illustrated embodiment, with threading 38 on the bolts corresponding to threading 40a,b on the inside surfaces of the passages 32a,b. Alternatively, where threading 40a,b is shown the cast steel part could also be countersunk in a hexagon form to permit a hexagon thread nut to be used to secure the cross member 34a,b.

To assemble the assembly 10, the connector 16 is pressed onto the lower end 18 of the upper tine segment 12, until the passage 32b lines up with the channel 24 in the segment 12. The cross member 34b can then be threaded into the passage 32b. As can be seen in the Figures, the cross member 34b will be generally flush with the surface of the connector 16 when fully inserted, again helping to avoid accumulation or bunching of materials around the connector 16. The lower tine segment 14 can then be inserted into the axial cavity 30, until the passage 32a lines up with the channel 22 in the segment 14, and then the cross member 34a can be threaded into the passage 32a.

Alternatively, the lower tine segment 14 can be connected to the connector 16 first, and then the connector 16 connected to the upper tine segment 12.

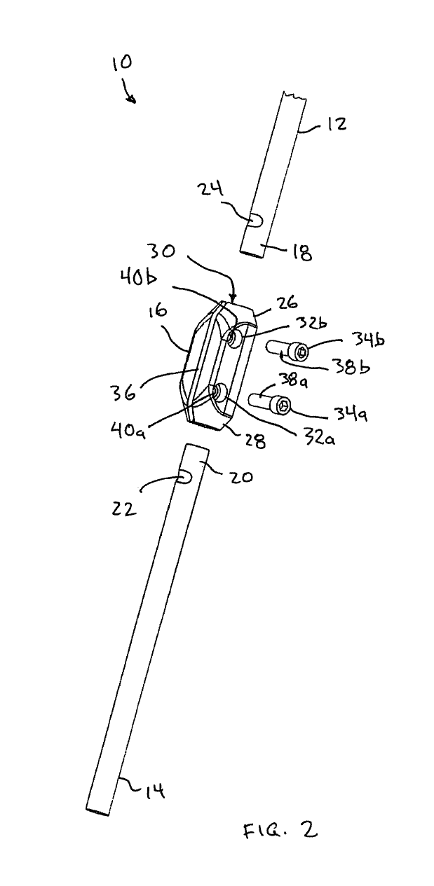

The connector 16 (shown in FIGS. 2 and 3) is further provided with an axial gap 36, such that in transverse cross-section the connector 16 would have a C-shaped structure. In the event that a segment 12, 14 becomes tightly held within the axial cavity 30 and it is desired to remove the segment 12, 14, a tool can be used as necessary to pry the gap 36 apart slightly to help free the target segment 12, 14.

The assembly 10 can be installed on a harrow implement and used in a conventional manner. In the event that the lower tine segment 14 is subject of damage or significant wear, one possible utility of the illustrated embodiment becomes clear. The cross member 34a can be unthreaded from the passage 32a, which releases the lower tine segment 14 and allows its removal from the axial cavity 30. In the event that the connector 16 itself becomes damaged or worn, it too can be removed by unthreading the cross member 34b from the passage 32b and pulling the connector 16 off of the lower end 18 of the upper tine segment 12. In the event that one of the two upper coil segments (which are illustrated in another embodiment in FIG. 7) should break, the two connectors 16 and lower tine segments 14 can then be removed and refitted to a new upper coil segment once the broken upper coil segment has been replaced.

While the above-described embodiment can be useful for quickly changing a lower tine segment that is subject of damage or wear, the above-described embodiment also provides desirable non-rotation functionality. As can clearly be seen, when assembled the cross members 34a,b pass through the connector 16 and engage the segments 12, 14, thus securing the segments 12, 14 and the connector 16 in a non-rotatable arrangement. This presents a significant advantage in that many modern tine pairs are increasingly being provided with wear members such as tungsten carbide plates directed in the direction of travel so as to be the leading face of the tine. The anti-rotation features of the exemplary embodiment thus can help ensure that such a wear member remains the leading face of the tine during use.

Moving to FIGS. 4 to 6, a second but related embodiment is illustrated. This second embodiment, an assembly 50, is primarily but not exclusively directed to the present invention as a retrofit of an existing harrow implement with conventional tine pairs. For example, if a conventional tine becomes damaged or substantially worn, it can be cut off at a certain height. The remaining tine segment—illustrated as upper tine segment 52—can be inserted into the upper section of the axial cavity 30 of a modified connector 54, and then welded or otherwise secured within the axial cavity 30. In the illustrated embodiment, the axial cavity 30 is provided with a weld surface 56, the intention being to weld the upper tine segment 52 against the weld surface 56. Note that the exemplary weld is located at the rear and at a narrow section of the upper tine segment 52 to better avoid stress risers and breakage of the spring steel. Other connection means will be obvious to those skilled in the art. The point at which the damaged tine would be cut to form the upper tine segment 52 would be determined based on the desired height of the completed assembly 50, which would normally be selected to match the length of the remaining tine of the tine pair.

With the upper tine segment 52 welded (or otherwise connected) to the connector 54, the lower tine segment 14 can be inserted into the axial cavity 30. The modified connector 54 is provided with only a single transverse passage 32a, and the segment 14 would be inserted until the channel 22 of the segment 14 aligns with the passage 32a. The cross member 34a can then be threaded into the passage 32a comprising threading 40 (shown in FIG. 5) to axially and rotationally secure the segment 14 at the desired location within the axial cavity 30.

As was the case with the first embodiment, the embodiment of FIGS. 4 to 6 allows for replacement of a damaged or worn tine tip. In the event that the lower tine segment 14 is subject of damage or significant wear, the cross member 34a can be unthreaded from the passage 32a, which releases the lower tine segment 14 and allows its removal from the axial cavity 30. The second embodiment also provides desirable non-rotation functionality, as the cross member 34a passes through the connector 54 and engages the segment 14, thus securing the segments 52, 14 and the connector 54 is a non-rotatable arrangement.

FIG. 7 illustrates a third embodiment of the present invention, showing a tine assembly 100 with means to non-rotationally secure the upper and lower tine segments of a quick-change arrangement.

The tine assembly 100 is shown mounted on a harrow pipe 106, the coil 104 of the assembly 100 wrapped around and secured to the pipe 106 in a conventional manner. The coil 104 is continued at opposite ends as tines 102a,b. Each tine 102a,b comprises an upper tine segment 108a,b and a lower tine segment 110a,b, the upper tine segment 108a,b connected to the lower tine segment 110a,b by means of a connector 112a,b.

While the connector 112a,b could be made from any material deemed suitable by a skilled person, it is preferably composed of stainless steel or cold drawn seamless mechanical. The connector 112a,b comprises an axial cavity 130a,b. The upper tine segment 108a,b comprises a lower end 114a,b sized and configured for insertion into the upper part of the axial cavity 130a,b, and the lower tine segment 110a,b comprises an upper end 118a,b sized and configured for insertion into the lower part of the axial cavity 130a,b. The upper and lower ends 118a,b and 114a,b are in facial contact when inserted into the axial cavity 130a,b, as described below.

The lower end 114a,b of the upper tine segment 108a,b is provided with a downwardly directed engagement face 116a,b. The engagement face 116a,b is angled off of normal, and while any off-normal angle may have utility (for non-limiting example between 10 and 80 degrees off the tine long axis) the engagement face 116a,b is preferably but not necessarily disposed at 45 degrees off the tine long axis. Correspondingly, the upper end 118a,b of the lower tine segment 110a,b is provided with an upwardly directed engagement face 120a,b, the engagement face 120a,b angled off of normal, preferably but not necessarily disposed at 45 degrees off the tine long axis, but in any event it must be an angle corresponding to the angle of the engagement face 116a,b. In this way, bringing the upper and lower ends 118a,b and 114a,b together inside the axial cavity 130a,b allows the two engagement faces 116a,b and 120a,b to connect and facially engage. This angled facial engagement of the upper and lower tine segments 108a,b and 110a,b is intended to prevent the lower tine segments 110a,b from turning or twisting, which would impair the proper function of the front-facing wear members, as described below.

The connector 112a,b has beveled upper and lower surfaces 126a,b and 128a,b, providing the benefits noted above with respect to the embodiments of FIGS. 1 to 6. The connector 112a,b is also provided with an upper passage 134a,b and a lower passage 132a,b. While the passages 134a,b and 132a,b are shown as opening to the side in FIG. 7, this is merely for better illustrating the feature, and they would preferably open rearwardly to avoid direct contact with soil, plants and other materials. The passages 134a,b and 132a,b are sized and configured to receive cross members 138 and 136, respectively. The cross members 136, 138 are shown as threaded bolts, with threading 140 and 142, respectively, on outer surfaces of the cross members 136, 138. The upper and lower passages 134a,b and 132a,b are provided with corresponding threading 146 and 144, respectively, to threadably receive the cross members 136, 138.

When the upper and lower tine segments 108a,b and 110a,b are fully inserted into the axial cavity 130a,b so that their terminal ends are in facial engagement, the cross member 138 is aligned to contact the upper tine segment 108a,b and the cross member 136 is aligned to contact the lower tine segment 110a,b.

However, the cross members 136, 138 are not intended to merely contact an outer surface of the upper and lower tine segments 108a,b and 110a,b in the illustrated embodiment. Instead, the upper and lower tine segments 108a,b and 110a,b are provided with shallow threaded recesses 124a,b and 122a,b, sized and configured to receive the ends of the cross members 136, 138 when the cross members 136, 138 are fully threaded into the passages 132a,b and 134a,b.

As can therefore be seen, the cross members 136, 138 secure the upper and lower tine segments 108a,b and 110a,b within the connector 112a,b when threaded into the passages 132a,b and 134a,b and the recesses 122a,b and 124a,b. In addition, when secured in this way, the angled facial connection of the engagement faces 116a,b and 120a,b prevents the upper and lower tine segments 108a,b and 110a,b from rotating relative to each other or the connector 112a,b.

The lower tine segments 110a,b are provided with lower ends 148a,b. The lower ends 148a,b may be provided with hard facing or tungsten carbide plating, as discussed above, although this is not shown since FIG. 7 is a rear view of the third embodiment. Given the anti-rotation features of the assembly 100 when all components are assembled as set forth above, the hard facing or tungsten carbide plating can be applied to the leading surface of the tines 102a,b with a reduced risk of rotation away from the direction of travel of the implement.

To assemble the assembly 100, the connector 112a,b is pressed onto the lower end 114a,b of the upper tine segment 108a,b, until the passage 134a,b lines up with the recess 124a,b in the segment 108a,b. The cross member 138 can then be threaded into the passage 134a,b and into the recess 124a,b. As can be seen in FIG. 7, the cross member 138 will be generally flush with the surface of the connector 112a,b when fully inserted, again helping to avoid accumulation or bunching of materials around the connector 112a,b. The lower tine segment 110a,b can then be inserted into the axial cavity 130a,b, until the passage 132a,b lines up with the recess 122a,b in the segment 110a,b, and then the cross member 136 can be threaded into the passage 132a,b and into the recess 122a,b. Alternatively, the lower tine segment 110a,b can be connected to the connector 112a,b first, and then the connector 112a,b connected to the upper tine segment 108a,b.

The assembly 100 can be installed on a harrow implement and used in a conventional manner. In the event that the lower tine segment 110a,b is subject of damage or significant wear, the cross member 136 can be unthreaded from the recess 122a,b and the passage 132a,b, which releases the lower tine segment 110a,b and allows its removal from the axial cavity 130a,b. In the event that the connector 112a,b itself becomes damaged or worn, it too can be removed by unthreading the cross member 138 from the recess 122a,b and the passage 134a,b and pulling the connector 112a,b off of the lower end 114a,b of the upper tine segment 108a,b. Appropriate replacement can then be undertaken and the implement put back into operation. Also, as stated above, if one of the two upper coil segments (shown in FIG. 7) breaks, the two connectors 112a,b and lower tine segments 110a,b can then be removed and refitted to a new upper coil segment once the broken upper coil segment has been replaced.

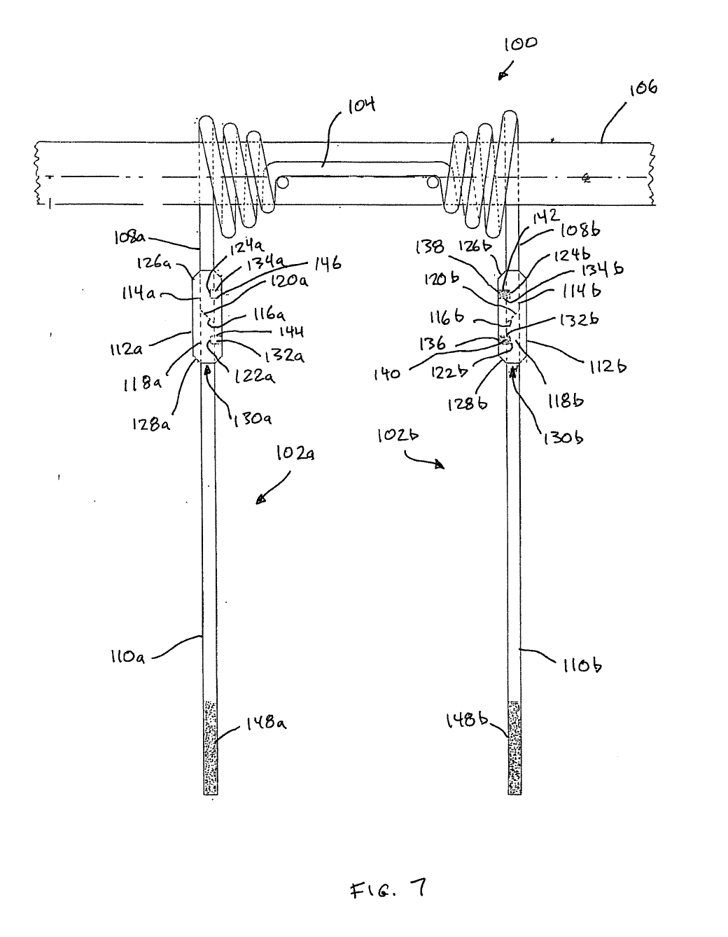

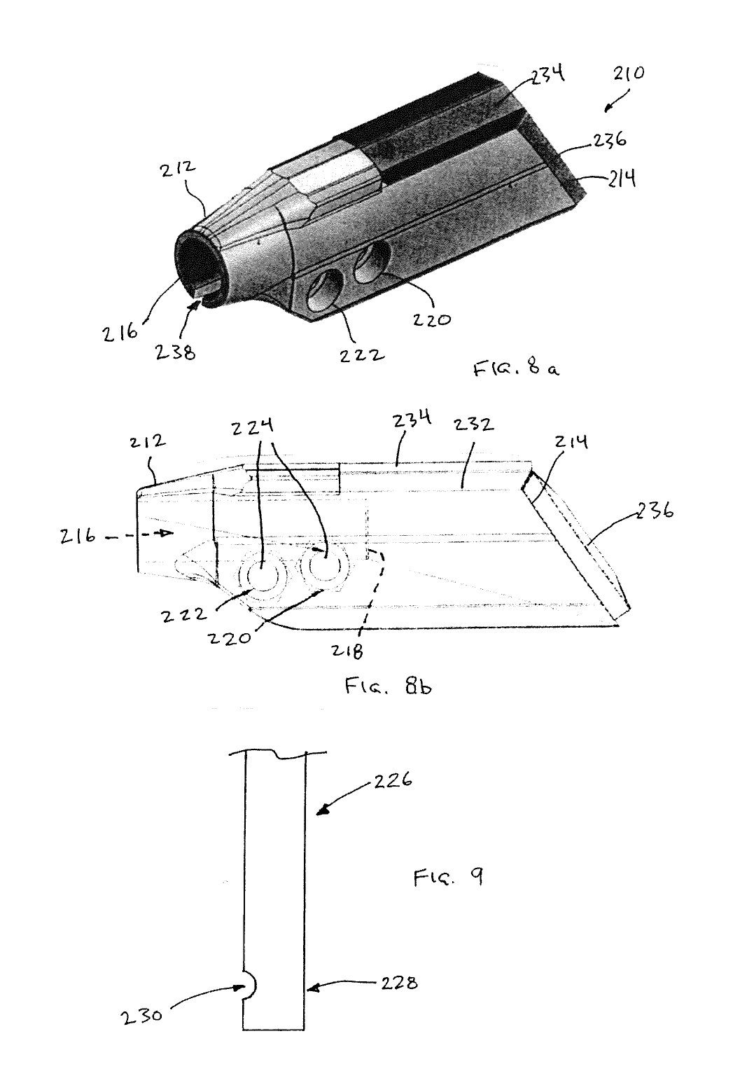

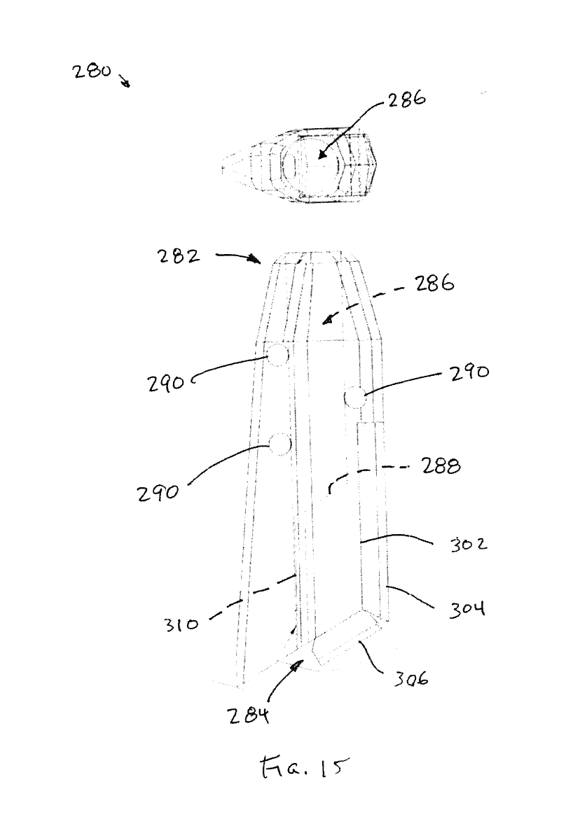

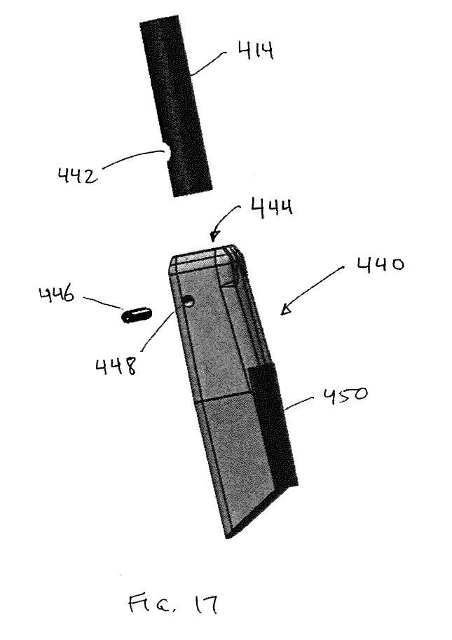

While the embodiments of FIGS. 1 to 7 illustrate a connector-type adaptor, the embodiments of FIGS. 8a to 15 illustrate alternative embodiments where the axial cavity and transverse passage are located within a replaceable tine tip for connection to a tine segment; in this way a worn or damaged tine tip can be replaced. FIGS. 16 to 18 illustrate an embodiment combining both the connector and replaceable tine tip features into one assembly.

Turning to FIGS. 8a to 11, a fourth embodiment of the present invention is illustrated. A tine tip 210 is shown comprising an axial gap 238, a transverse passage 220 for locking (which can also be used for tightening in certain embodiments), and a transverse passage 222 for tightening, as will be described below.

The tine tip 210 comprises an upper end 212 and a lower end 214, and in the illustrated embodiment extends axially between the upper and lower ends 212, 214. The tine tip 210 is intended to be connected to a tine segment 226, which segment 226 may be part of a single tine assembly or a tine pair. FIG. 9 illustrates part of the tine segment 226. The tine segment 226 extends downwardly from the remainder of the single tine or tine pair (not shown), and would normally terminate in a tine tip; however, the tip has been removed in the present invention—either because of wear or breakage, or to allow connection to the tine tip 210 at the point of manufacture. The tine segment 226 may be manufactured without a conventional tip, or the original tip may be removed after wear or breakage to allow use of the tine tip 210.

The tine segment 226 terminates at a lower end 228, which will be received in the tine tip 210 as described below. The tine segment 226 is provided with a transverse channel 230 extending across the lower end 228 of the tine segment 226. While the transverse channel 230 is shown as being perpendicular to the long axis of the tine segment 226, the channel 230 could be at another angle, for one non-limiting example 45 degrees off of the long axis. The channel 230 is configured for threaded or slip-fit receipt of a corresponding bolt or pin, as described below.

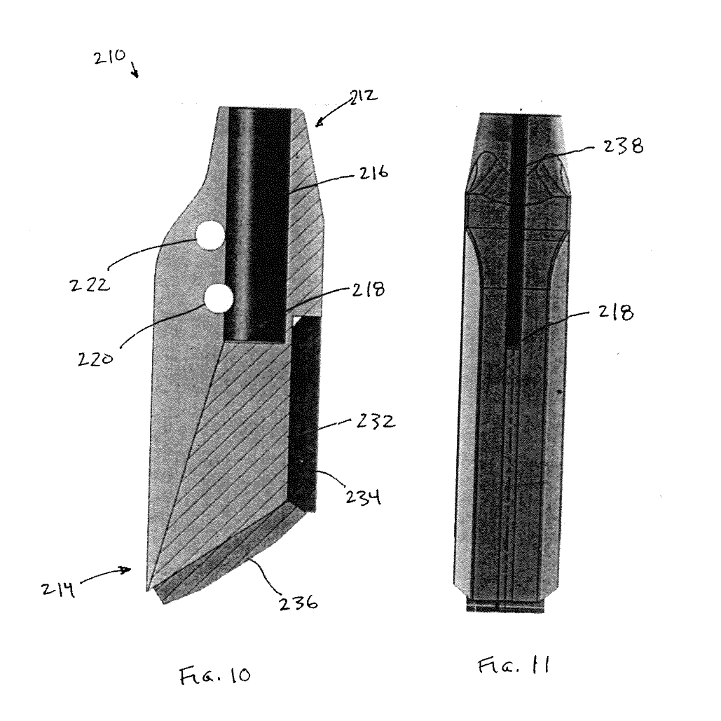

Turning to FIGS. 8a, 8b and 10, the tine tip 210 is shown as having an internal, cylindrical axial cavity 216 extending from the upper end 212 approximately halfway through the tine tip 210 to terminate at a bottom surface 218. The axial cavity 216 is sized and configured for receipt of the lower end 228 of the upper tine segment 226. In use, the lower end 228 of the segment 226 would be inserted into the axial cavity 216 through the upper end 212 of the tip 210, until the lower end 228 abuts the bottom 218. It is preferable for the lower end 228 to directly abut the bottom 218 to avoid having the upward vertical force or load on the bolts (described below). That being said, there may be an axial gap of up to ¼ inch between them, or even a greater distance, with an appropriate assembly design that takes into account the need to prevent shearing of the bolts, which would be within the knowledge of the person skilled in the art.

The tine tip 210 is also provided with two transverse passages—a locking transverse passage 220 (which can also be used for tightening where the bolt is threaded) and a tightening transverse passage 222, which can be seen in section in FIG. 10. The locking transverse passage 220 extends through the body of the tine tip 210 and impinges on the axial cavity 216, and in doing so creates a three-dimensional area where the axial cavity 216 and the transverse passage 220 overlap. This overlap area provides the means for locking the lower end 228 of the upper tine segment 226 within the axial cavity 216. While the passage 220 is shown as being perpendicular to the long axis of the tine tip 210, it could be another angle (such as, for non-limiting example, 45 degrees) so long as it corresponds with the orientation of the channel 230.

FIG. 8b shows a bolt 224 threadably received within the transverse passage 220. While other connection members such as roll pins could be used, a threaded engagement member is preferred for robustness, and the presence of countersinking ensures that the bolt 224 does not extend beyond the outside dimensions of the tine tip 210.

In assembling the tine assembly, the lower end 228 of the upper tine segment 226 would be inserted into the axial cavity 216 at the upper end 212 of the tine tip 210. When the lower end 228 abuts the bottom 218 of the axial cavity 216, the tine tip 210 would be rotated relative to the upper tine segment 226 until the transverse channel 230 aligns with the passage 220. In so doing, the cylindrical passage 220 would remain unobstructed by the lower end 228, and the bolt 224 can then be inserted into the passage 220. With the bolt 224 threadably inserted into the passage 220, the bolt 224 is also in slip-fit engagement with the transverse channel 230 on the lower end 228 of the upper tine segment 226. With the bolt 224 in the passage 220 and engaging the channel 230, the lower end 228 of the upper tine segment 226 is locked within the axial cavity 216 and cannot be removed. Also, the bolt 224 ensures that the lower end 228 of the upper tine segment 226 cannot be rotated within the axial cavity 216. The lower end 228 of the upper tine segment 226 is thus axially and rotationally locked within the axial cavity 216.

It will be clear that while only one transverse passage 220 and corresponding bolt 224 is illustrated, more than one such passage can be incorporated into embodiments of the present invention.

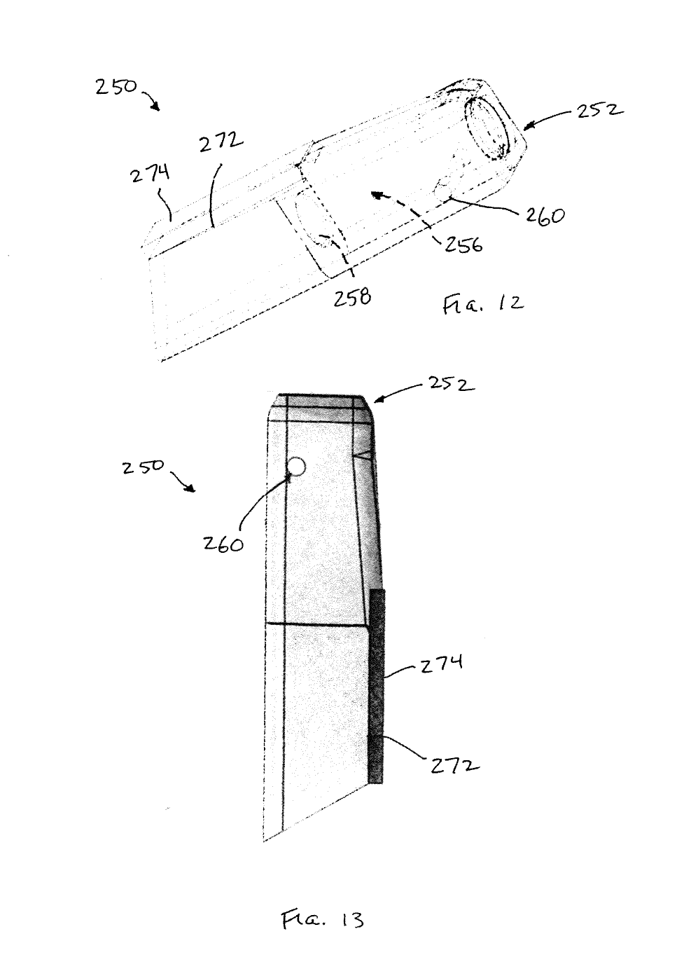

As can be seen in FIGS. 8a, 8b and 10, a second transverse passage 222 is also present. This transverse passage 222 functions to further secure the lower end 228 of the upper tine segment 226 within the axial cavity 216. The tine tip 210 is provided with an axial gap 238, best seen in FIG. 11, which extends the entire length of the tine tip 210 between the upper and lower ends 212, 214, the tine tip 210 in transverse cross-section thus having a C-shaped structure. Either before or after insertion of the lower end 228 into the axial cavity 216, a second bolt 224 would be threaded into the passage 222. By subsequently tightening the bolt 224 in the passage 222 after insertion of the lower end 228 of the segment 226, the axial gap 238 would be gradually closed or at least reduced in order to grip the lower end 228 within the axial cavity 216.

It will be clear that while only one transverse passage 222 and corresponding bolt 224 is illustrated, more than one such passage can be incorporated into embodiments of the present invention.

The embodiment of FIGS. 8a to 11 also shows the presence of wear-resistant attachments. As stated above, it is known in the art to apply wear-resistant coatings or members to tines, to reduce wear and breakage. The tine tip 210 comprises a leading face or surface 232 which is directed in the intended direction of travel of the implement, and a bottom at the lower end 214 of the tip 210. The leading surface 232 is provided with a wear-resistant member 234, which is preferably but not necessarily composed of tungsten carbide. The bottom of the lower end 214 of the tip 210 is also provided with a wear-resistant member 236, which is preferably but not necessarily composed of tungsten carbide. Because of the anti-rotation functionality as described above, the tine tip 210 will remain in the desired position with the wear-resistant member 234 pointed in the direction of travel.

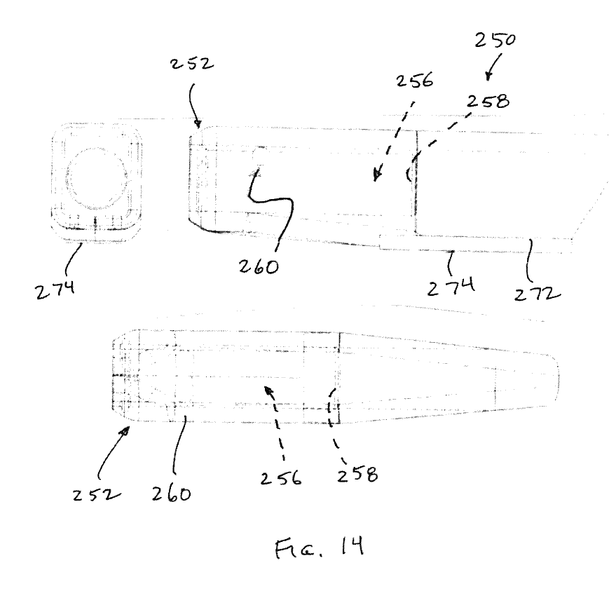

Turning now to FIGS. 12 to 14, a further exemplary embodiment of the present invention is illustrated. In this embodiment, a tine tip 250 is provided that employs only a single transverse passage and no axial gap.

The tine tip 250 comprises an internal, cylindrical axial cavity 256 extending from an upper end 252 approximately halfway through the tine tip 250 to terminate at a bottom surface 258. The tine tip 250 is intended to be connected to a tine segment, as described above with respect to the embodiment of the tine tip 210. The axial cavity 256 is sized and configured for receipt of the lower end of the upper tine segment.

The tine tip 250 is also provided with a single transverse passage 260—this is a locking passage akin to the locking transverse passage 220 described above. The locking transverse passage 260 extends through the body of the tine tip 250 and impinges on the axial cavity 256, and in doing so creates a three-dimensional area where the axial cavity 256 and the transverse passage 260 overlap. This overlap area provides the means for locking the lower end of the upper tine segment within the axial cavity 256.

While not shown, a cross member such as a bolt or roll pin is intended to be received within the transverse passage 260.

Akin to the preceding embodiment described above, the lower end of the upper tine segment would be inserted into the axial cavity 256 at the upper end 252 of the tine tip 250. When the lower end abuts the bottom 258 of the axial cavity 256, the tine tip 250 would be rotated relative to the upper tine segment until the transverse channel of the lower end aligns with the passage 260. The cylindrical passage 260 thus remains unobstructed by the lower end, and a bolt or roll pin can then be inserted into the passage 260. The lower end of the upper tine segment is therefore locked within the axial cavity 256, and the bolt or roll pin ensures that the lower end of the upper tine segment cannot be rotated within the axial cavity 256. The lower end of the upper tine segment is thus axially and rotationally locked within the axial cavity 256. It will be clear that while only one transverse passage 260 is illustrated, more than one such passage can be incorporated into embodiments of the present invention.

This embodiment also shows the presence of a wear-resistant attachment. Specifically, the tine tip 250 comprises a leading face or surface 272 which is directed in the intended direction of travel of the implement. The leading surface 272 is provided with a wear-resistant member 274, which is preferably but not necessarily composed of tungsten carbide. Because of the anti-rotation functionality as described above, the tine tip 250 will thus remain in the desired position with the wear-resistant member 274 pointed in the direction of travel.

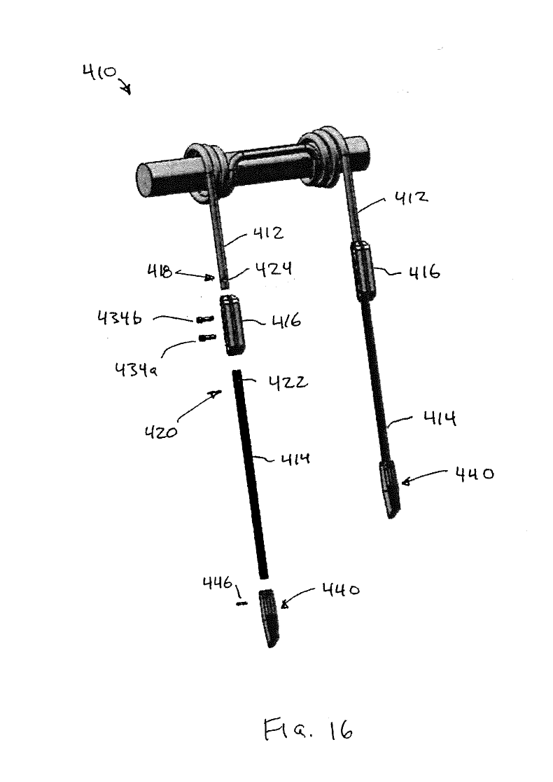

Turning to FIG. 15, a further exemplary embodiment is illustrated. In this embodiment, a plurality of cross members are intended to be used with the tine tip 280. The tine tip 280 comprises upper and lower ends 282, 284, and an axial cavity 286 similar in many respects to those axial cavities described above.

The tine tip 280 comprises three transverse passages 290. These are locking passages, and they are intended to receive cross members such as bolts or roll pins (not shown). Unlike the embodiments described above, however, the areas of overlap between the axial cavity 286 and each of the passages 290 are relatively small, with only a small encroachment or impingement. The passages 290 are, though, configured to allow the cross members to press against the sides of a tine segment lower end when inserted into the axial cavity 286.

In a further distinguishing feature when compared to the other embodiments described above, this embodiment comprises a sloped bottom 288 to the axial cavity 286, sloping rearwardly and downwardly toward a drainage port 310. In this manner, any fluids or contaminants that enter the axial cavity 286 at the upper end 282 of the tip 280 can proceed downwardly and drain through the port 310.

The embodiment also shows the presence of wear-resistant attachments. The tine tip 280 comprises a leading face or surface 302 which is directed in the intended direction of travel of the implement, and a bottom at the lower end 284 of the tip 280. The leading surface 302 is provided with a wear-resistant member 304, which is preferably but not necessarily composed of tungsten carbide. The bottom of the lower end 284 of the tip 280 is also provided with a wear-resistant member 306, which is preferably but not necessarily composed of tungsten carbide. Because of the anti-rotation functionality as described above, the tine tip 280 will remain in the desired position with the wear-resistant member 304 pointed in the direction of travel.

Turning now to FIGS. 16 to 18, a yet further exemplary embodiment is illustrated. In this embodiment, features of some of the above embodiments are combined into a single assembly 410. Specifically, the assembly 410 comprises both a connector 416 for connecting upper and lower tine segments 412, 414, and a replaceable tine tip 440.

The connector 416 (shown in detail in FIG. 18) comprises an axial cavity 430 for receipt of the lower end 418 of the upper tine segment 412 and for receipt of the upper end 420 of the lower tine segment 414. The lower end 418 comprises an upper transverse channel 424 for engagement by an upper cross member 434b, and the upper end 420 comprises a lower transverse channel 422 for engagement by a lower cross member 434a. The cross members 434a,b are configured for receipt within corresponding lower and upper transverse passages 432a,b, in a manner described above.

The connector 416 also comprises an axial gap 436, akin to axial gaps described above. While not shown, tightening cross members can be used in the other illustrated transverse passages (shown in FIG. 18) to close or at least reduce the axial gap 436.

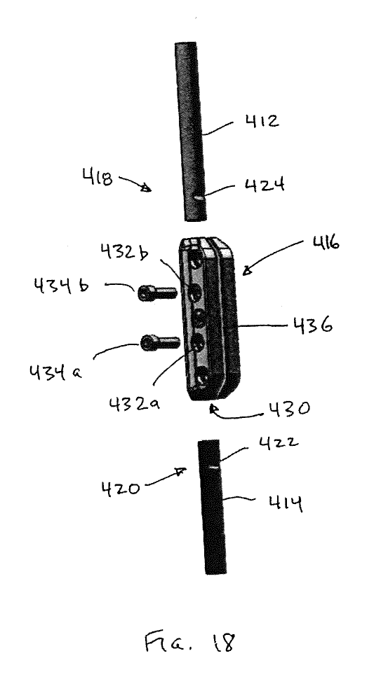

At the lower end of the lower tine segment 414 (see FIG. 17), a replaceable tine tip 440 is illustrated. As with the above embodiments, the tine tip 440 comprises an axial cavity 444 for receipt of the lower end of the lower tine segment 414, and a transverse passage 448 for receipt of a cross member 446. The lower end is provided with a transverse channel 442.

When the lower end is inserted into the axial cavity 444 and rotated such that the transverse channel 442 aligns with the transverse passage 448, the cross member 446 can be inserted or threaded into the transverse passage 448 to lock the lower end of the lower tine segment 414 to the tine tip 440. While a roll pin is illustrated as being the cross member 446, a threaded bolt may be preferred for robustness.

In addition, a leading face of the tine tip 440 can be provided with a tungsten carbide member 450.

Unless the context clearly requires otherwise, throughout the description and the claims:
“comprise”, “comprising”, and the like are to be construed in an inclusive sense, as opposed to an exclusive or exhaustive sense; that is to say, in the sense of “including, but not limited to”.
“connected”, “coupled”, or any variant thereof, means any connection or coupling, either direct or indirect, between two or more elements; the coupling or connection between the elements can be physical, logical, or a combination thereof.
“herein”, “above”, “below”, and words of similar import, when used to describe this specification shall refer to this specification as a whole and not to any particular portions of this specification.
“or”, in reference to a list of two or more items, covers all of the following interpretations of the word: any of the items in the list, all of the items in the list, and any combination of the items in the list.
the singular forms “a”, “an” and “the” also include the meaning of any appropriate plural forms.

Words that indicate directions such as “vertical”, “transverse”, “horizontal”, “upward”, “downward”, “forward”, “backward”, “inward”, “outward”, “vertical”, “transverse”, “left”, “right”, “front”, “back”, “top”, “bottom”, “below”, “above”, “under”, and the like, used in this description and any accompanying claims (where present) depend on the specific orientation of the apparatus described and illustrated. The subject matter described herein may assume various alternative orientations. Accordingly, these directional terms are not strictly defined and should not be interpreted narrowly.

Where a component (e.g. a circuit, module, assembly, device, etc.) is referred to herein, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

Specific examples of methods and apparatus have been described herein for purposes of illustration. These are only examples. The technology provided herein can be applied to contexts other than the exemplary contexts described above. Many alterations, modifications, additions, omissions and permutations are possible within the practice of this invention. This invention includes variations on described embodiments that would be apparent to the skilled person, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

The foregoing is considered as illustrative only of the principles of the invention. The scope of the claims should not be limited by the exemplary embodiments set forth in the foregoing, but should be given the broadest interpretation consistent with the specification as a whole.

1. A harrow tine assembly comprising:
a first tine segment;
a second tine segment; and
a cross member;
the first tine segment comprising an axial cavity and a transverse passage, the transverse passage impinging on the axial cavity;
an end of the second tine segment retained within the axial cavity, the end comprising a transverse channel in a surface thereof;
the cross member received within the transverse passage and engaging the transverse channel to non-rotatably lock the first and second tine segments, such that removal of the cross member from the transverse passage allows disconnection of the first and second tine segments.

2. The harrow tine assembly of claim 1 wherein the first tine segment comprises a tine tip and the second tine segment comprises an upper tine segment.

3. The harrow tine assembly of claim 1 wherein the first tine segment comprises an upper tine segment and the second tine segment comprises a lower tine segment.

4. The harrow tine assembly of claim 3 wherein the axial cavity extends between first and second openings, receiving the end of the second tine segment in the first opening and a third tine segment in the second opening.

5. A harrow tine adaptor for receiving and selectively retaining a tine segment, the harrow tine adaptor comprising:
an axial cavity; and
a transverse passage, the transverse passage impinging on the axial cavity;
the axial cavity configured for receipt of an end of the tine segment, the end comprising a transverse channel in a surface thereof;
the transverse passage configured for receipt of a cross member;
the cross member engaging the transverse channel when received within the transverse passage to non-rotatably lock the harrow tine adaptor and the tine segment, such that removal of the cross member from the transverse passage allows disconnection of the harrow tine adaptor and the tine segment.

6. A harrow tine assembly comprising:
an upper tine segment comprising a lower end;
a lower tine segment comprising:
an upper end; and
a transverse channel in a surface of the lower tine segment spaced from the upper end;
a connector comprising an axial cavity retaining the lower end of the upper tine segment and the upper end and the transverse channel of the lower tine segment, the connector comprising a transverse passage therethrough at a location beside the transverse channel;
and
a cross member selectively retained within the transverse passage and engaging the transverse channel, such that the lower tine segment and the connector are non-rotatably engaged.

7. The harrow tine assembly of claim 6 further comprising:
an upper transverse channel in a surface of the upper tine segment;
an upper transverse passage through the connector; and
an upper cross member retained within the upper transverse passage and engaging the upper transverse channel, such that the upper tine segment and the connector are non-rotatably engaged.

8. The harrow tine assembly of claim 6 wherein the lower end of the upper tine segment and the upper end of the lower tine segment abut within the axial cavity.

9. The harrow tine assembly of claim 6 wherein the connector further comprises an axial gap extending from an outer surface into the axial cavity.

10. A harrow tine assembly comprising:
an upper tine segment comprising a lower end, the lower end having an off-normal angled lower engagement face;
a lower tine segment comprising an upper end and a recess in a surface of the lower tine segment spaced from the upper end, the upper end having an off-normal angled upper engagement face corresponding to the off-normal angled lower engagement face of the lower end of the upper tine segment;
a connector comprising:
an axial cavity retaining the lower end of the upper tine segment and the upper end and the recess of the lower tine segment; and
a passage extending from an outer surface into the axial cavity beside the recess; and
a cross member selectively retained within the passage and engaging the recess;
the lower end of the upper tine segment abutting the upper end of the lower tine segment within the axial cavity such that the off-normal angled lower engagement face and the off-normal angled upper engagement face are in facial engagement;
such that the upper tine segment, the lower tine segment and the connector are non-rotatably engaged.

11. The harrow tine assembly of claim 10 further comprising:
an upper recess in a surface of the upper tine segment spaced from the lower end;
an upper passage extending from the outer surface of the connector into the axial cavity beside the upper recess; and
an upper cross member retained within the upper passage and engaging the upper recess.

12. A harrow tine assembly comprising:
a tine tip comprising:
an axial cavity; and
a transverse passage passing at least partially through the tine tip and impinging on the axial cavity;
an upper tine segment comprising a lower end, the lower end comprising a transverse channel in a surface thereof, the lower end received within the axial cavity such that the transverse channel aligns with the transverse passage; and
a cross member selectively retained within the transverse passage and engaging the transverse channel, such that the upper tine segment and the tine tip are non-rotatably connected;
such that removal of the cross member from the transverse passage allows removal of the lower end from the axial cavity.

13. The harrow tine assembly of claim 12 wherein the tine tip comprises a wear-resistant leading surface.

14. The harrow tine assembly of claim 13 wherein the wear-resistant leading surface comprises a wear-resistant member attached to a leading face of the tine tip.

15. The harrow tine assembly of claim 12 wherein the tine tip further comprises an axial gap extending from an outer surface into the axial cavity, such that closing the axial gap
securely retains the lower end of the upper tine segment in the axial cavity.

16. The harrow tine assembly of claim 15 wherein the transverse passage extends across the axial gap and the cross member is a bolt threadably received in the transverse passage, such that tightening the bolt closes the axial gap.

17. The harrow tine assembly of claim 12 wherein a downwardly-facing surface of the tine tip is wear resistant.

18. The harrow tine assembly of claim 17 wherein the downwardly-facing surface comprises a wear-resistant member.

19. A harrow tine assembly comprising:
a tine tip comprising:
an axial cavity;
an axial gap extending from an outer surface of the tine tip into the axial cavity;
at least one transverse passage passing at least partially through the tine tip and impinging on the axial cavity; and
at least one gap-spanning passage passing at least partially through the tine tip and across the axial gap;
an upper tine segment comprising:
a lower end received within the axial cavity; and
at least one transverse channel in a surface of the lower end such that each transverse channel aligns with the corresponding transverse passage impinging on the axial cavity;
a locking cross member selectively retained within each transverse passage; and
a tightening cross member selectively retained within each gap-spanning passage;
the locking cross member releasably and non-rotatably connecting the upper tine segment and the tine tip; and
the tightening cross member for selectively closing the axial gap to securely retain the lower end of the upper tine segment in the axial cavity.

20. The harrow tine assembly of claim 19 wherein the tine tip comprises a wear-resistant leading surface.

21. The harrow tine assembly of claim 20 wherein the wear-resistant leading surface comprises a wear-resistant member attached to a leading face of the tine tip.

22. The harrow tine assembly of claim 19 wherein a downwardly-facing surface of the tine tip is wear resistant.

23. The harrow tine assembly of claim 22 wherein the downwardly-facing surface comprises a wear-resistant member.

24. The harrow tine assembly of claim 19 wherein the tightening cross member is a bolt threadably received in the gap-spanning passage.

25. A removable harrow tine tip for use with a harrow tine segment, the harrow tine segment having a lower end with a surface comprising a transverse channel, the tip comprising:
an axial cavity;
a transverse passage impinging on the axial cavity; and
a cross member selectively receivable within the transverse passage;
the axial cavity configured for receipt of the lower end such that the transverse channel aligns with the transverse passage; and
the cross member configured to engage the transverse channel when received within the transverse passage;
such that the upper tine segment and the tine tip are non-rotatably connected when the lower end is received within the axial cavity and the cross member is received within the transverse passage to engage the transverse channel; and
such that removal of the cross member from the transverse passage allows removal of the lower end from the axial cavity.

26. The harrow tine tip of claim 25 further comprising a wear-resistant leading surface.

27. The harrow tine tip of claim 26 wherein the wear-resistant leading surface comprises a wear-resistant member attached to a leading face of the harrow tine tip.

28. The harrow tine tip of claim 25 further comprising an axial gap extending from an outer surface into the axial cavity, such that closing the axial gap securely retains the lower end of the upper tine segment in the axial cavity.

29. The harrow tine tip of claim 28 wherein the transverse passage extends across the axial gap and the cross member is a bolt threadably receivable in the transverse passage, such that tightening the bolt closes the axial gap.

30. The harrow tine tip of claim 25 wherein a downwardly-facing surface of the harrow tine tip is wear resistant.

31. The harrow tine tip of claim 30 wherein the downwardly-facing surface comprises a wear-resistant member.

32. A harrow tine assembly comprising:
an upper tine segment comprising a lower end, the lower end comprising an upper transverse channel in a surface thereof;
a lower tine segment comprising an upper end and an opposite end, the upper end comprising a lower transverse channel in a surface thereof;
a connector comprising:
an axial cavity extending between upper and lower openings, the upper opening selectively retaining the lower end and the upper transverse channel and the lower opening selectively retaining the upper end and the lower transverse channel;
an upper transverse passage impinging the axial cavity at a location beside the upper transverse channel; and
a lower transverse passage impinging the axial cavity at a location beside the lower transverse channel;
an upper cross member selectively retained within the upper transverse passage and engaging the upper transverse channel to lock the upper tine segment to the connector;
a lower cross member selectively retained within the lower transverse passage and engaging the lower transverse channel to lock the lower tine segment to the connector; and
a tine tip, the tine tip comprising:
a tip axial cavity;
a tip transverse passage impinging on the tip axial cavity; and
a tip cross member selectively receivable within the tip transverse passage;
the tip axial cavity configured for receipt of the opposite end of the lower tine segment, the opposite end of the lower tine segment having a tip transverse channel is a surface thereof, such that the tip transverse channel aligns with the tip transverse passage; and
the tip cross member configured to engage the tip transverse channel when received within the tip transverse passage, thus locking the tine tip to the lower tine segment.
